(19) United States
(12) Patent Application Publication
(10) Pub. No.: US 2004/0003891 A1
(43) Pub. Date: Jan. 8, 2004

(54) Apparatus and method for application of adhesive substances to objects

(75) Inventors: Chi Wah Cheng, Honk Kong (CN); Kin Yik Hung, Hong Kong (CN); Ping Chun (Benson) Chong, Hong Kong (CN); See Lok Chan, Hong Kong (CN)

Correspondence Address: OSTROLENK FABER GERB & SOFFEN, 1180 AVENUE OF THE AMERICAS, NEW YORK, NY, 100368403

(73) Assignee: ASM Assembly Automation Ltd.

(21) Appl. No.: 10/189,883

(22) Filed: Jul. 2, 2002

(51) Int. Cl. B32B 31/00

(52) U.S. Cl. 156/297; 156/541; 156/578

(57) ABSTRACT

The invention provides an apparatus and method for the application of adhesive substances to objects, such as solder balls, for the purpose of mounting them onto substrates. The apparatus comprises an applicator having a layer of the adhesive substance and a pick carrier to carry objects and move the objects from a supply source to a substrate for mounting the objects thereon. The applicator is located so that the applicator applies the adhesive substance to the objects while the objects carried on the pick carrier are moving between the supply source and the substrate.

### FIELD OF THE INVENTION

The present invention relates to an apparatus for the application of adhesive substances to objects, such as solder balls, for mounting these objects onto substrates. Although the following description relates to the application of an adhesive substance, namely flux, to solder balls, it should be appreciated that the invention is of wider application.

### BACKGROUND AND PRIOR ART

Placement apparatus are used to mount objects such as solder balls onto substrates. More specifically, flux is a common adhesive used for affixing solder balls onto the substrates. Flux is either applied onto the solder balls themselves or onto the electrodes (pads) of substrates. The application can be done in various ways.

One way to apply flux is called screen printing, wherein a small amount of flux is deposited onto the pads of a Ball Grid Array (BGA) substrate through small holes of a stencil by using a pair of squeegees. That is similar to conventional printing.

Another method for applying flux is achieved by pin transfer. A small amount of flux is deposited on pads of a BGA substrate by stamping small pins with flux onto the pads. Examples of patents applying such a process are U.S. Pat. Nos. 5,695,667 and 6,013,899 (“Method and apparatus for mounting soldering balls onto electrodes of a substrate or a comparable electronic component”). A problem with these processes is that they are sequential. There has to be a flux deposition by pin transfer followed by a ball placement process, and that has to be done sequentially for the various substrate pad positions. This results in a slower cycle time even though a flux application head and a ball pick head may move nearly simultaneously. Moreover, it may be necessary to perform alignment twice; alignment is required once for the flux pick head when applying flux on the substrate, and again for alignment of the ball pick head with the substrate for ball placement. There is also a higher tooling cost, as it requires pins and a flux application head. Furthermore, inaccurate flux deposition with respect to balls may occur.

An alternative method for applying flux for mounting of solder balls is by direct dipping. Such a method is disclosed in U.S. Pat. No. 5,284,287 (“Method for attaching conductive balls into a substrate”) and U.S. Pat. No. 6,099,681 (“Mounting apparatus for mounting small balls and mounting method thereof”). Solder balls are directly dipped into a layer of flux and therefore flux is applied on the lower part of the balls. For example, in U.S. Pat. No. 5,284,287, a ball pick head picks up solder balls by vacuum, lowers the solder balls into a bath layer of flux without the balls touching the bottom of a recess in the flux plate. Then it withdraws the balls from the flux and aligns the balls with respect to corresponding pads on a BGA substrate before releasing the balls.

The problem is that this method has an even slower cycle time compared to the pin transfer and screen print methods, as both operations of the pick head, pick ball and pick flux processes are sequential. As for U.S. Pat. No. 6,099,681, it also includes a touch sensor installed in the ball pick head to detect when the balls touch the bottom plane of the flux. Once the balls touch the bottom plate, the head lifts and the lower part of the balls carry with them a certain amount of flux. This causes an appreciable risk of damaging the balls because of the softness of the balls, if they are made from solder. The large inertia of the ball pick head leads to difficulty in stopping its motion and balancing its weight to achieve soft contact on the bottom plane of the flux plate.

Thus, the problems with the present methods of applying flux include slow cycle time because of the need to execute sequential processes, and high tooling cost and inaccurate flux deposition in the case of pin transfer. For the screen print method, when there is an obstacle on the top surface of the substrate, the method will be very difficult to implement and inefficient.

### SUMMARY OF THE INVENTION

It is an object of the present invention to avoid some of the above problems with the prior art and to provide an improved apparatus and method for applying flux for the mounting of objects such as solder balls onto substrates.

According to one aspect of the invention, it provides an apparatus for applying an adhesive substance to objects, comprising an applicator having a layer of the adhesive substance, and a pick carrier to carry objects and move the objects from a supply source to a substrate for mounting the objects thereon, the applicator being located so that the applicator applies the adhesive substance to the objects while the objects carried on the pick carrier are moving between the supply source and the substrate.

According to another aspect of the invention, it provides a method of applying an adhesive substance to objects, comprising the steps of carrying objects from a supply source to a substrate for mounting the objects on the substrate, and applying the adhesive substance to the objects while the objects are moving between the supply source and the substrate.

It will be convenient hereinafter to describe the invention in greater detail by reference to the accompanying drawings which illustrate one embodiment of the invention. The particularity of the drawings and the related description is not to be understood as superseding the generality of the broad identification of the invention as defined by the claims.

### BRIEF DESCRIPTION OF THE DRAWINGS

FIG. 1 shows a general overview of main components of an apparatus according to a preferred embodiment of the invention.

FIG. 2 illustrates a pick head picking up a plurality of solder balls and moving in the direction of a flux applicator.

FIG. 3a illustrates some of the plurality of solder balls having a film of flux applied on them after passing the flux applicator.

FIG. 3b shows an enlarged view of FIG. 3a, relating to the application of a film of flux from the flux applicator onto the solder balls.

FIG. 4 illustrates the plurality of solder balls having a film of flux applied on them, and positioned by the pick head over a substrate for mounting onto the substrate.

FIG. 5 is a top view of the main components of the apparatus shown in FIGS. 1-4.

FIG. 6 illustrates a second preferred embodiment of an apparatus according to the invention.

FIG. 7 illustrates a third preferred embodiment of an apparatus according to the invention.

FIG. 8 shows an alternative arrangement of the flux applicator to prepare a thin layer of flux on the flux applicator.

### DETAILED DESCRIPTION OF THE PREFERRED EMBODIMENT OF THE INVENTION

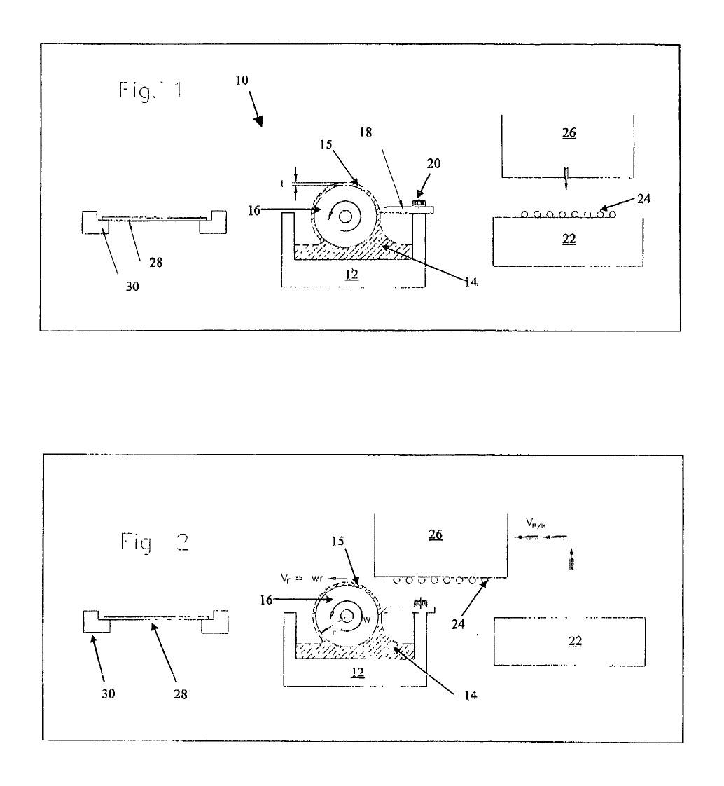

FIG. 1 shows a general overview of main components of an apparatus 10 according to a preferred embodiment of the invention. The apparatus 10 includes a container in which an adhesive substance is storable, such as a flux container 12 which contains a flux reservoir 14. A flux applicator 16 comprising a roller is placed into contact with the flux reservoir 14 and is rotatably driven. The lower portion of the flux applicator 16 is maintained in contact with the flux reservoir 14. As the flux reservoir 14 is in contact with the flux applicator 16, and due to the high viscosity and adhesiveness of the flux, the flux adheres to it. A film of flux 15 is formed around the flux applicator 16 as it is rotated.

To ensure an even spread of flux 15 on the flux applicator 16, a flux razor 18 is placed adjacent to the flux applicator 16 to adjust a thickness of the film of flux by cropping any excess. Consequently, a film of flux 15 with a uniform depth t is formed. The thickness of the flux layer 15 is controllable by adjusting the gap between the flux applicator 16 and the flux razor 18. The flux razor 18 may be attached to the flux container 12 using screws 20. Preferably, the arrangement of the flux razor 18 matches the direction of rotation of the flux applicator 16 in such a way that a thicker layer of flux 15 sticking on the flux applicator 16 is brought towards the razor 18. Therefore, a uniform layer of flux is 15 formed on the upper part of the flux applicator 16 with a thickness thinner than that before passing the flux razor 18.

The illustrated embodiment of the invention also includes a supply of objects such as solder balls to be mounted onto a substrate, for instance a solder ball supply unit 22 to supply a plurality of solder balls 24 on one side of the flux container 12. A pick means, such as a pick head 26 that uses vacuum suction or other adhering means to carry solder balls 24 is lowered in order to pick up the solder balls 24 on the ball supply unit 22. On the opposite side of the flux container 12 is a BGA substrate 28 onto which the solder balls 24 are to be mounted. The BGA substrate 28 is placed onto a substrate holder 30, awaiting a ball placement process.

FIG. 2 illustrates the pick head 26 picking up the plurality of solder balls 24 and moving in the direction of the flux applicator 16.

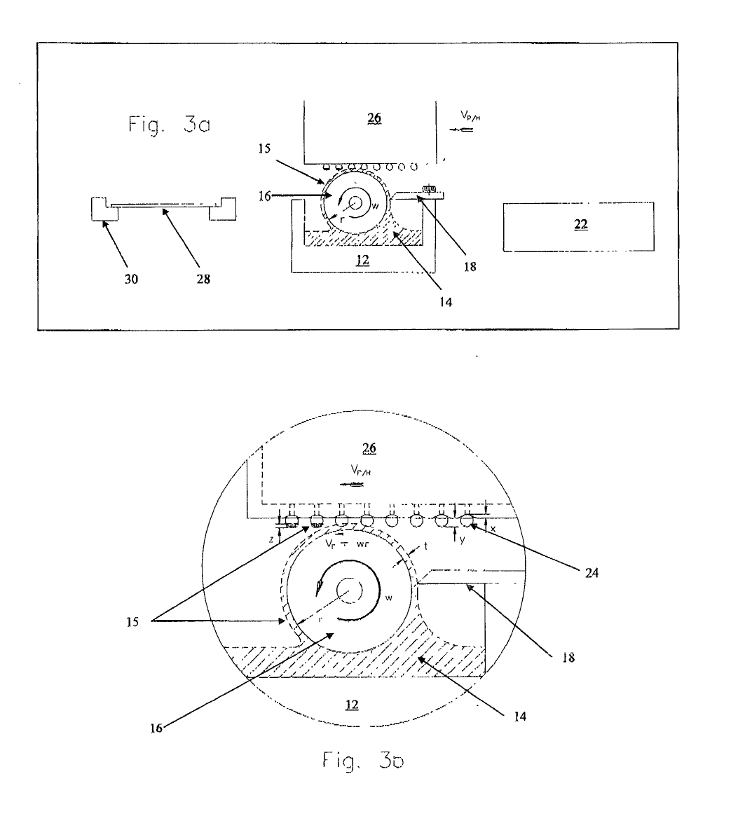

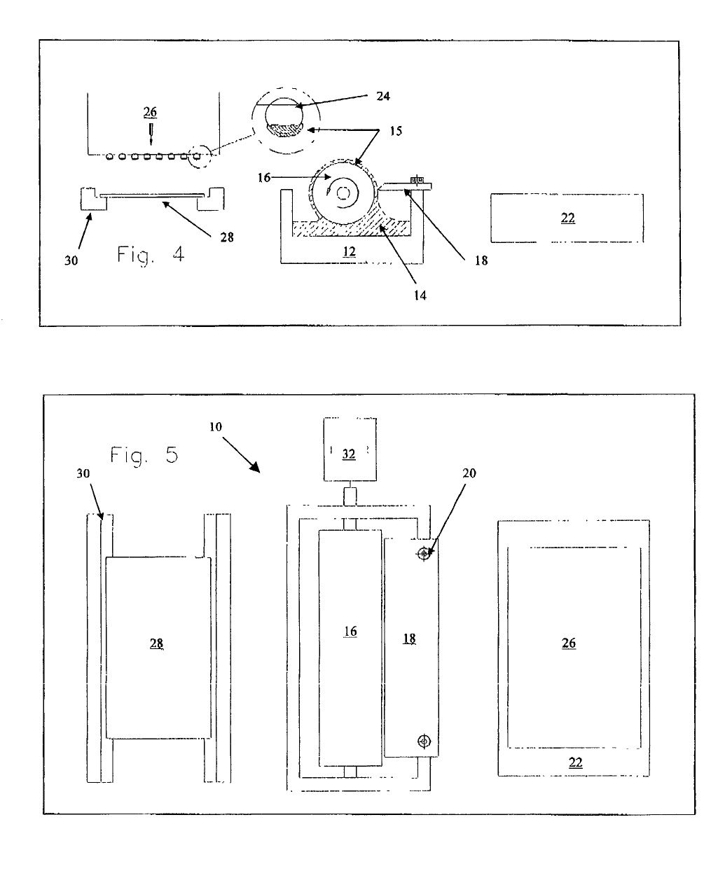

FIG. 3a illustrates some of the plurality of solder balls 24 having a film of flux 15 applied on them after passing the flux applicator 16. The thickness t of the flux 15 is preferably a bit larger or close to the diameter of the solder balls 24 The lowest part of the solder balls 24 should be higher than the flux applicator 16, so that the balls 24 will not be damaged by hitting the flux applicator 16, but should be low enough to be in contact with the layer of flux 15. It is preferred that the tangential speed of the flux applicator 16 (Vᵣ) is equal or close to the traveling speed of the pick head 26 (V_{P/H}) as the pick head 26 carries the solder balls 24 over the film of flux 15. This is to ensure little or no relative motion between the top part of the flux layer 15 and the moving solder balls 24 and to facilitate even spread of the flux 15 onto the solder balls 24. As a result, on-the-fly flux application is achieved, that is, the pick head 26 does not stop and continues moving towards the substrate 28 during flux application.

FIG. 3b shows an enlarged view of FIG. 3a, relating to the application of a film of flux 15 from the flux applicator 16 onto the solder balls 24. Each solder ball 24 has a layer of flux of depth z at its base. To avoid the flux 15 contaminating the pick head 26, the depth z is smaller than y (the height of the ball exposed from the small cavity on the pick head 26). The depth z is typically in the range of ⅕ to ⅔ of the ball diameter.

FIG. 4 illustrates the plurality of solder balls 24 having a film of flux 15 applied on them, and positioned by the pick head 26 over the substrate 28 for mounting onto the substrate 28. Alignment of the pick head 26 with respect to the substrate 28 can be done if necessary. The pick head 26 is then lowered so that the base of the solder balls 24 are in close proximity with the substrate 28 and the solder balls 24 are then released. Since there is a layer of flux 15 at the base of the solder balls 24, the solder balls 24 adhere to the substrate 28 once they are released by the pick head 26. The pick head is then positioned back over the ball supply unit 22 to collect the next batch of solder balls 24.

FIG. 5 is a top view of the main components of the apparatus 10 shown in FIGS. 1-4. In addition to the components already mentioned above, FIG. 5 also shows a rotary motor 32 that is used to drive the flux applicator 16.

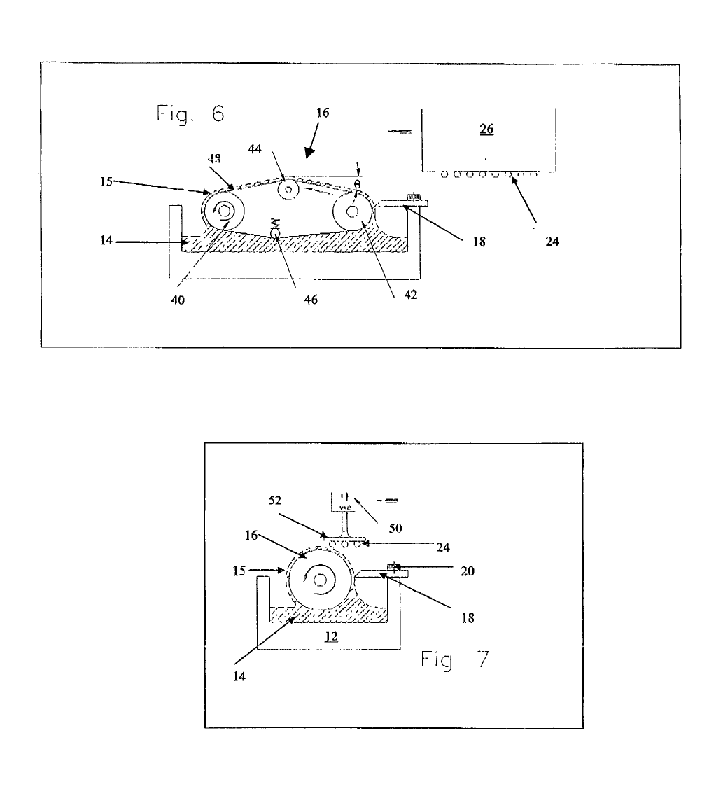

FIG. 6 illustrates a second preferred embodiment of an apparatus 10 according to the invention. In this embodiment, the flux applicator 16 includes a driving roller 40, a driven roller 42, a fluxing roller 44 and an idler 46, which are linked by a closed belt 48. The driving roller 40 is activated by a motor (not shown) and this drives the system to rotate and move through a closed belt 48 linking all the rollers 40, 42, 44 and idler 46. The belt 48 can be made from plastic or metal, but preferably anti-static. The driven roller 42 is placed opposite to the driving roller 40. The fluxing roller 44 is positioned centrally in between the driving and driven rollers. The idler 46 is a preload roller placed at the lower side of the belt 48.

This second embodiment uses the general principle of flux application as for the first embodiment. However, the fluxing roller 44 is adjustable vertically and thus the inclination angle θ of the upper side of the belt 48 is changeable. The smaller the inclination angle θ, the flatter the top portion of the belt 48 would be. This leads to a longer contact time between the flux layer 15 and the solder balls 24 carried by the pick head 26. Therefore, by adjusting the vertical position of the fluxing roller 44, the contact time for flux application on the solder balls 24 can be changed and controlled for different requirements.

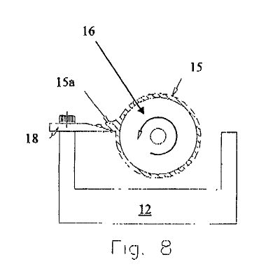

FIG. 7 illustrates a third preferred embodiment of an apparatus 10 according to the invention. Instead of a pick head 26 carrying solder balls 24, this embodiment has a pick arm 50 that carries a chip 52 that has been bumped with a plurality of solder balls 24. Similarly, the chip 52 with a plurality of solder balls 24 are carried over a film of flux 14 to apply a layer of flux 15 to the base of the solder balls 24. The solder balls 24 and chip 52 are then mounted onto a substrate (not shown).

FIG. 8 shows an alternative arrangement of the flux applicator 16 to prepare a thin layer of flux on the flux applicator 16. Under this arrangement, the flux razor 18 is placed on a side of the flux container 12 away from the initial position of the pick head 26. Since a flux reservoir is not necessary, any contraption to support the flux razor 18 would be sufficient. A sufficient amount of flux 15a is applied on the top part of the flux razor 18 and some flux is preferably also applied to the upper portion of the flux applicator 16 near the flux razor 18. When the flux applicator 16 is rotated in the direction shown, the flux 15a accumulated on the flux razor 18 is carried through the gap between the flux razor 18 and the surface of the flux applicator 16 so that a flux layer 15 of uniform thickness is formed on the surface of the flux applicator 16. The advantage of having this arrangement is that the flux applicator consumes less flux as compared to having a flux reservoir, but is still able to produce a consistent and uniform flux layer 15 on the flux applicator 16.

It would be appreciated that the invention shortens the ball mounting cycle time as the flux application method is not sequential. Thus, it is a truly on-the-fly process. Since no extra tooling (such as pin transfer head tooling or screen print tooling) is required, tooling cost can be reduced. Furthermore, as compared to the pin transfer method and/or screen print method, system cost is reduced because no mechanism for handling the pin transfer head or screen print is required. The present invention also serves to avoid the problem of inaccurate flux deposition of a substrate, which may occur with the pin transfer and screen print methods.

The invention described herein is susceptible to variations, modifications and/or additions other than those specifically described and it is to be understood that the invention includes all such variations, modifications and/or additions which fall within the spirit and scope of the above description.

What is claimed is:

1. An apparatus for applying an adhesive substance to objects, comprising:
an applicator having a layer of the adhesive substance; and
a pick carrier to carry objects and move the objects from a supply source to a substrate for mounting the objects thereon, the applicator being located so that the applicator applies the adhesive substance to the objects while the objects carried on the pick carrier are moving between the supply source and the substrate.

2. An apparatus according to claim 1, wherein the applicator is a roller.

3. An apparatus according to claim 1, wherein the layer of adhesive substance envelops the applicator.

4. An apparatus according to claim 3, further comprising a motor driving the applicator in a revolving motion.

5. An apparatus according to claim 4, wherein the motor drives the applicator to rotate in the direction in which the objects are moved by the pick carrier.

6. An apparatus according to claim 4, wherein the tangential speed of rotation of the applicator is equal or close to the moving speed of the objects by the pick carrier as the applicator applies the adhesive substance to the objects.

7. An apparatus according to claim 1, wherein the depth of an object in contact with the adhesive substance is between ⅕ and ⅔ of the diameter of the object.

8. An apparatus according to claim 1, wherein the pick carrier is so positioned with respect to the applicator at application of the adhesive that the objects enter the adhesive substance layer to a depth for applying the adhesive substance to the object, yet small enough to avoid contact between the pick carrier and the adhesive substance layer.

9. An apparatus according to claim 1, further comprising a reservoir containing the adhesive substance, the applicator being partially immersed in the adhesive substance in the reservoir, and the applicator includes a section thereof above the reservoir on which the adhesive substance layer is held for contacting the moving objects.

10. An apparatus according to claim 1, including a cutter adjacent to the applicator to adjust a selected thickness of the layer of adhesive substance by cropping any excess of the adhesive substance before the objects move into the layer.

11. An apparatus according to claim 10, further comprising a quantity of adhesive substance added to the applicator proximate to the cutter to generate the layer of adhesive substance.

12. An apparatus according to claim 1, wherein the applicator comprises a plurality of rollers positioned for defining a guide path for a belt and comprises a belt linking the rollers and guided by the rollers, the belt having an outward side with respect to its path over the rollers, and the layer of adhesive substance is constituted on outward side of the belt.

13. An apparatus according to claim 12, wherein the rollers comprise at least one driving roller and two other rollers, all of the rollers guiding the belt.

14. An apparatus according to claim 12, wherein the relative positions of the rollers are adjustable to vary a length of the belt with the layer of adhesive substance that make contact with objects during application.

15. An apparatus according to claim 1, wherein the adhesive substance is flux.

16. An apparatus according to claim 1, wherein the objects are solder balls.

17. A method of applying an adhesive substance to objects, comprising the steps of carrying objects from a supply source to a substrate for mounting the objects on the substrate, and applying the adhesive substance to the objects while the objects are moving between the supply source and the substrate.

18. A method according to claim 17, further comprising applying the layer of adhesive substance to the objects with an applicator.

19. A method according to claim 18, further comprising enveloping the applicator with the layer of adhesive substance.

20. A method according to claim 19, further comprising driving the applicator in a revolving motion as the objects move over the applicator.

21. A method according to claim 20, wherein the applicator is driven to revolve in the direction of movement of the objects past the applicator.

22. A method according to claim 20, wherein the applicator is rotated such that the tangential speed of revolution of the applicator is equal or close to the moving speed of the objects as the objects move past the applicator and the applicator applies the adhesive substance to the objects.

23. A method according to claim 18, wherein the objects are supported as they are moved past the applicator so that the depth of an object in contact with the adhesive substance is between ⅕ and ⅔ of the diameter of the object.

24. A method according to claim 18, further comprising partially immersing the applicator in a reservoir containing the adhesive substance.

25. A method according to claim 18, further including cutting the layer of adhesive substance on the applicator to adjust the thickness of the layer.

26. A method according to claim 25, wherein the cutting comprises adding a quantity of adhesive substance to the applicator proximate to the cut to generate a layer of the adhesive substance.

27. A method according to claim 18, wherein the applicator comprises a plurality of rollers and a belt linking the rollers, the belt having an outward side with respect to its path over the rollers, the method comprising guiding the belt to move over the rollers and applying the layer of adhesive substance on the outward side of the belt.

28. A method according to claim 27, further comprising driving at least one of the rollers to rotate to move the belt over the rollers.

29. A method according to claim 27, further comprising adjusting the relative positions of the rollers to vary a length of the belt with adhesive substance thereon that makes contact with objects during application.

30. A method according to claim 17, wherein the adhesive substance is flux.

31. A method according to claim 17, wherein the objects are solder balls.
